(19) United States
(12) Patent Application Publication
(10) Pub. No.: US 2022/0244712 A1
(43) Pub. Date: Aug. 4, 2022

(54) Production System and Assembly Method Thereof

(71) Applicant: Hitachi, Ltd., Chiyoda-ku, Tokyo (JP)

(72) Inventors: Masakazu AOKI, Tokyo (JP); Hidehiko FUSHIMI, Tokyo (JP); Hideyuki GOTOU, Tokyo (JP); Naoya TOBISAWA, Tokyo (JP)

(21) Appl. No.: 17/761,440

(22) PCT Filed: Mar. 31, 2020
(86) PCT No.: PCT/JP2020/014913

§ 371 Date: Mar. 17, 2022

(51) Int. Cl. G05B 19/418

(52) U.S. Cl. CPC G05B 19/41865; G05B 19/41815

(57) ABSTRACT

The present invention provides a production system including: a base-unit-width specifier that specifies a base-unit width that is the common width of a plurality of base units on which a plurality of control devices and a plurality of controlled devices are mounted; a production controller that performs an operation test on the controlled devices in a first region; a disassembly condition determiner that determines a disassembly condition to disassemble the production system in units of modules such that each of the control devices and the corresponding one of the controlled devices are included in the same module, and that the dimension and weight of each module do not exceed an allowable dimension and an allowable load weight of a conveyance apparatus; and a transportation schedule setter that determines the order in which the plurality of modules are transported from the first region to a second region.

### TECHNICAL FIELD

The present invention relates to a production system and an assembly method thereof.

### BACKGROUND ART

As a background technique in this technical field, Patent Literature 1 listed below discloses “a robotic cell for assembling parts by using multiple robots, comprising: multiple trestles on which the multiple robots are mounted, respectively; opening portions, which are open in respective one side surfaces of the multiple trestles; a connecting member configured to couple two adjacent trestles on the one side surfaces of the multiple trestles with the multiple trestles adjoining one another so that the opening portions of the multiple trestles are oriented in one direction; and fastening units configured to fasten the connecting member to the two adjacent trestles while bringing both end portions of the connecting member into surface contact with the two adjacent trestles, respectively.” (see claim 1).

Patent Literature 2 listed below discloses “a unit-shaped article production apparatus characterized in that the unit-shaped article production apparatus comprises: a pair of conveyor devices placed to be apart from and in parallel with each other, each having a movable part driven in a direction opposite to the other; a driving motor that is provided with each of the pair of conveyor devices and drives the movable part of each of the pair of conveyor devices; a transportation pallet that is placed on the movable part of the conveyor device; a work device that processes or assembles an article placed on the transportation pallet or a measurement device that measures a physical characteristic of the article; and a housing that houses the pair of conveyor devices, the driving motors, the transportation pallet, the work device or the measurement device.” (see claim 1).

### CITATION LIST

### Patent Literature

Patent Literature 1: JP2011-224742A
Patent Literature 2: JPH07-001298A

### SUMMARY OF INVENTION

### Technical Problem

With recent sophistication of production systems such as production lines, there are cases in which a user (a party that uses a production system to produce products), such as a production system user, outsources building of an entire production system to a supplier (an outsourcing contractor who builds the production system) such as a production system manufacturer, and the number of cases is increasing. In such a case, in the case where an old production system is operating in the user factory, in many cases, the operation of the old production system is stopped and removed, and then the new production system is installed and set up in this user factory. Hence, the user has a demand for making the time for installing and setting up the new production system as short as possible. In other words, the demand of the user for a new production system is that the user wants to shorten the time until the operation of the new production system starts. The foregoing Patent Literature 1 and Patent Literature 2 do not disclose any contrivance that can be used in the supplier factory to respond to this demand. Thus, there is a problem that it is difficult to shorten the time until the operation of the new production system starts.

The present invention has been made in light of the foregoing situation, and an object thereof is to provide a production system and an assembly method thereof that make it possible to shorten the time until the start of operation.

### Solution to Problem

A production system according to the present invention to the above-described problem includes a plurality of control devices and a plurality of controlled devices each connected to one of the control devices, including: a base-unit-width specifier that specifies a base-unit width that is the width of a plurality of base units on which the plurality of control devices and the plurality of controlled devices are mounted, such that the base-unit width is narrower than a second delivery-entrance width that is the width of a delivery entrance of a second region to which the production system is transported or an allowable width of a conveyance apparatus that transports the production system from a first region to the second region; a production controller that performs an operation test on the controlled devices in the first region in a state where the plurality of control devices and the plurality of controlled devices are mounted on the base units having the specified base-unit width; a disassembly condition determiner that determines a disassembly condition to disassemble the production system in units of modules, such that each of the control devices and the corresponding one of the controlled devices are included in the same module, and that the dimension and weight of each module do not exceed an allowable dimension and an allowable load weight of the conveyance apparatus; and a transportation schedule setter that determines the order in which the plurality of modules are transported from the first region to the second region.

### Advantageous Effects of Invention

With the present invention, it is possible to shorten the time until the operation of a production system starts.

### BRIEF DESCRIPTION OF DRAWINGS

FIG. 1 is a schematic perspective view of a production system according to a first preferred embodiment;

FIG. 2 is a schematic perspective view of a production line;

FIG. 3 is a schematic perspective view of base units;

FIG. 4 is a block diagram of a design-production management device and others;

FIG. 5 is a diagram showing the relationship between base units in an installation work;

FIG. 6 is a diagram showing the positional relationship between the engagement portions of base units;

FIG. 7 is a diagram showing a display example of modules in a modification example; and

FIG. 8 is a diagram showing a display example in which the module configuration in FIG. 7 is changed.

### DESCRIPTION OF EMBODIMENTS

### Premises of Embodiment

With sophistication in production systems in recent years, businesses called robot SI (system integrate) and line building have been expanded. There are cases in which advanced products cannot be produced only by combining conventional general-purpose robotic cells and modules. Hence, a business has begun in which a supplier, who is an outsourcing contractor, receives an outsourcing contract to build the entire production system. When a supplier assembles a production system at the factory on the supplier side (supplier factory), the supplier assembles the production system in consideration of the layout of the site of the factory on the user side, who is the client, (user factory). Then, the supplier performs an operation test to check if the assembled production system operates as it is designed. Then, the supplier disassembles the production system for which the operation test has been finished into predetermined parts and transports the predetermined disjointed parts to the user factory.

The supplier, then, assembles the production system at the user factory by combining the transported predetermined parts. The assembled production system undergoes an operation test at the user factory. Then, the user starts the operation of the production system that has passed the operation test. Nowadays, with the sophistication of the production system along with the sophistication of products, a production system has a length of tens to hundreds of meters in some cases, and a demand is increasing for production systems having scales that cannot be built by using general-purpose robotic cells.

In the user factory, an old production system has been working in many cases. Hence, in some cases, robot SIers (robot system integrators) on the supplier side cannot assemble a new production system in the user factory. In addition, since the user cannot produce their products during the time allocated to assemble the new production system in the user factory, a new production system is desired to be assembled and set up in the user factory as rapidly as possible.

According to the technique employing the foregoing Patent Literature 1, it is conceivable that a plurality of robotic stations 100 can be arranged in consideration of changes in the configuration of the production system and the maintainability of the trestle. This makes it possible to change the configuration of the production system that has once set up, as necessary in the user factory. However, although this technique makes it possible to shorten the assembly time of the production line in the user factory, the techniques does not refer to shortening the set-up time. In addition, according to Patent Literature 1, a power controller box inserted in the robotic station controls the robotic arm. Patent Literature 1 discloses that a plurality of robotic stations 100 are combined to build a robotic cell which is a production system including a series of stations. However, since the technique does not refer to how to connect the power controllers to one another, it does not refer to cooperation between robotic stations. Hence, in this technique, an operation test and other checks need to be performed after coupling the robotic stations to one another, and hence, there is a possibility that this may increase the set-up time. In other words, because the robotic station 100 can probably operate independently, this technique takes account of the case where the user itself changes the production system in the user factory. Patent Literature 1 does not disclose a technical idea for any contrivance for shortening the set-up time at the user factory by the supplier.

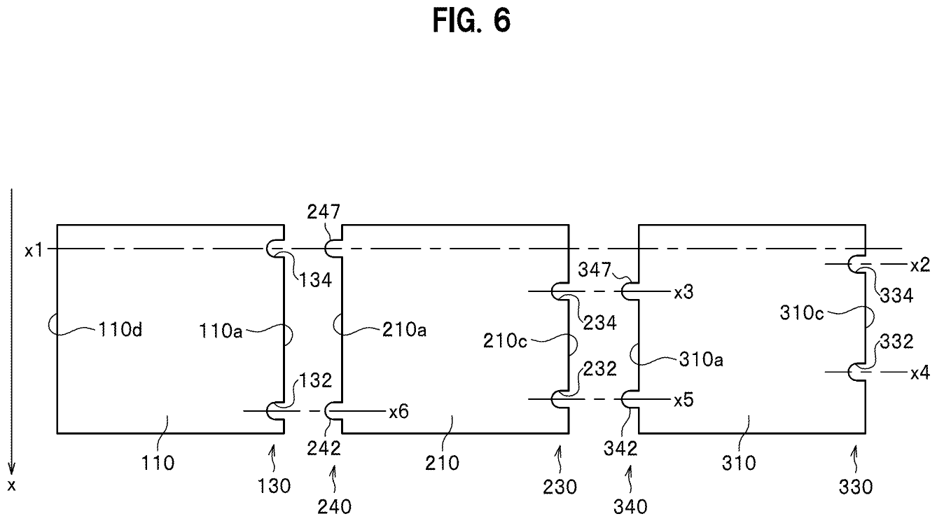

With the technique employing the foregoing Patent Literature 2, it is conceivable that a housing 50 in consideration of relocation of the production line and process changes can be formed. A central control device 55 in this housing 50 is electrically connected to the central control devices 55 in the other units via a relay board 54. Patent Literature 2 discloses that a manual work unit 71 shown in FIG. 6 is inserted as part of the units and shows that positively combining the housings 50 having the same size makes it easy to change the production line. In other words, this technique aims at the configuration change of the production line in the user factory where production is performed; thus, the technique is probably for changing the production line or changing processes by the user itself in the user factory. In other words, Patent Literature 2, as in Patent Literature 1, does not disclose a technical idea for any contrivance for shortening the set-up time at the user factory by the supplier. Patent Literature 2 does not take account of shortening the assembly time and the set-up time of the production line in the user factory in the case of building an outsourced production line, and thus it neither describes nor suggests any configuration or contrivance for performing an operation test in the supplier factory. Thus, the object of the embodiment described later had probably not been recognized.

In addition, according to the technique employing the configuration of Patent Literature 2, in the case where the production system (which is stated as the production line in Patent Literature 2) is complicated, or in the case where devices or configurations other than a multi-axis screw tightening robot, a dielectric-strength measuring device, and the like, which can be housed in the housing 50 described in Patent Literature 2, are necessary, and thus a configuration occurs in which those devices cannot be housed in the housing 50, the mechanism of the housing 50 cannot be used as it is.

In addition, in order for the supplier to meet demands from the user, the production line needs to be one that is adapted to the layout of the user factory. However, in some cases, the production line is not formed in a straight line, and Patent Literature 1 and Patent Literature 2 do not take account of cases where it is difficult to arrange the robotic stations 100 described in Patent Literature 1 or the general-purpose housings 50 described in Patent Literature 2 or cases where devices need to be mounted on base units having different sizes and shapes.

Besides, since devices are arranged on base units having the same size and shape, some base units have a very small number of devices and other units have a very large number of devices, and this contrarily decreases the efficiency of transportation and the efficiency of assembling and setting up. Such cases are not taken into account.

Further, in the case where base units have only one size and shape, and the number of devices is large, the number of input and output ports connected to the I/O modules of control devices runs short, such as IoT (Internet of Things) controllers, programmable automation controllers (PACs), programmable logic controllers (PLCs), and industrial personal computers (IPCs), and wiring may have to connect between base units. Such cases are also not taken into account.

Thus, when such a situation occurs, wiring and an operation test after wiring have to be carried for each base unit of the production system in the user factory, and this increases the set-up time of the production system.

As described above, both the techniques employing Patent Literature 1 and 2 are about robotic stations or housings within the user factory. In summary, these techniques are not for making work efficient in the process in which “the production system is assembled once in advance at a place other than the user factory (for example, at the supplier factory), the production system is disassembled into parts, and then the disjointed parts are assembled in the user factory”. Hence, an object of the following preferred embodiment is to set up a sophisticated production system in a rapid manner at the client factory by performing an operation test of the production system at the supplier factory.

### First Embodiment

### Configuration and Operation of First Embodiment

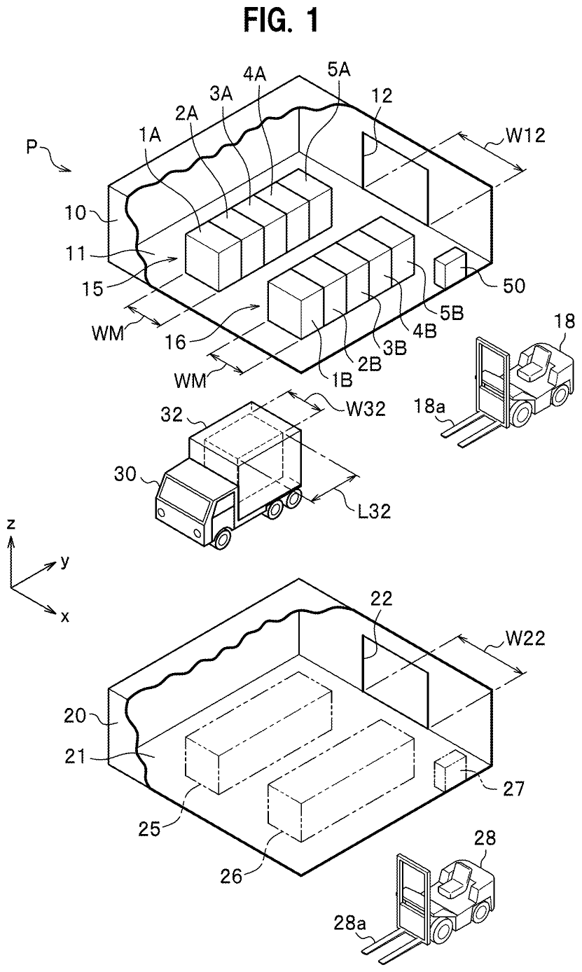

FIG. 1 is a schematic perspective view of a production system P according to a first preferred embodiment.

In FIG. 1, the production system P includes two production lines 15, 16 and a design-production management device 50. The factory of the supplier who builds the production system P is called the supplier factory 10 (the first region), and the factory of the user who uses the production system P is called the user factory 20 (the second region). The production system P, in the state shown in the figure, is placed on a floor surface 11 of the supplier factory 10.

The production line 15 includes a plurality of (five in the example in the figure) modules 1A (a first module), 2A (a second module), 3A (a third module), 4A, 5A. Similarly, the production line 16 includes a plurality of (five in the example in the figure) modules 1B, 2B (a fourth module), 3B, 4B, 5B. The production lines 15, 16 both are production lines for performing printing, inspection, packaging, and the like on products and have the same or similar functions. Hence, the functions of the modules 1A, 2A, 3A, 4A, 5A and the modules 1B, 2B, 3B, 4B, 5B are the same or similar. Hence, the modules 1A to 5A and 1B to 5B are collectively called “the modules 1, 2, 3, 4, 5” or “the modules 1 to 5” in some cases. The modules are units into which the assembled production system P is disassembled into or knocked down into. The sizes and shapes of the modules can be different from one another, and the modules are also called cells. Each module or each cell may be configured to have a function unit such as printing, inspection, packaging, cutting, or welding. Each module or each cell may be configured to have two or more functions in consideration of wiring and the center of gravity of each base unit which will be described later.

The modules 1A to 5A and 1B to 5B are arranged in two lines along a horizontal direction. This arrangement direction is defined as the y-axis direction, the direction orthogonal to the y axis on the horizontal plane as the x-axis direction, and the up-down direction as the z-axis direction. The width of the modules 1 to 5 in the X-axis direction is called the module width WM. The supplier factory 10 has a delivery entrance 12 having a delivery-entrance width W12 (a first delivery-entrance width). The user factory 20 has a delivery entrance 22 having a delivery-entrance width W22 (a second delivery-entrance width). The supplier factory 10 and the user factory 20 have forklifts 18, 28 with forks 18a, 28a.

The production system P is disassembled into units of modules at the supplier factory 10 and conveyed by the forklift 18 into a conveyance apparatus 30 which is, for example, a truck. The conveyance apparatus 30 is not limited to a truck but may be a trailer or a container. The conveyance apparatus 30 conveys the production system P to the user factory 20. The production system P disassembled into units of modules is conveyed into the user factory 20 by the forklift 28. Then, the delivered production system P is installed inside the user factory 20.

The areas 25, 26, 27 indicated by dashed double-dotted lines in the user factory 20 are areas where the production lines 15, 16 and the design-production management device 50 are respectively installed. FIG. 1 shows only one conveyance apparatus 30, but the number of conveyance apparatuses 30 may be two or more. The conveyance apparatus 30 has a loading platform 32. The width of the internal space of the loading platform 32 is called the loading-platform inside width W32 (allowable width), and the length of the internal space of the loading platform 32 is called the loading-platform inside length L32. The conveyance apparatus 30 transports the production system P from the supplier factory 10 to the user factory 20 by going back and forth multiple times as necessary between the supplier factory 10 and the user factory 20. The module width WM of the production lines 15, 16 is narrower than the delivery-entrance widths W12, W22 and also narrower than the loading-platform inside width W32.

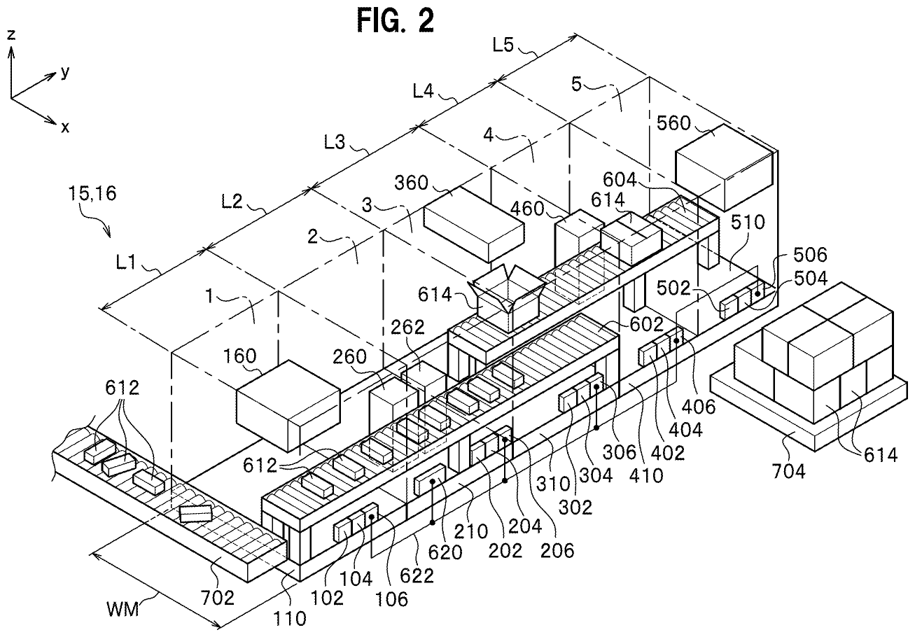

FIG. 2 is a schematic perspective view of the production line 15 or 16.

The production line 15, 16, as described above, includes the modules 1 to 5. The lengths of the modules 1, 2, 3, 4, 5 in the y-axis direction are respectively called the module lengths L1, L2, L3, L4, L5. Adjoining the module 1 is disposed a roller conveyor 702. The roller conveyor 702 is connected to a not-shown manufacturing apparatus. Products 612 produced in the manufacturing apparatus are supplied to the production lines 15, 16 via the roller conveyor 702 with the orientations of the products 612 irregular.

The production line 15, 16 prints text or the like on the product 612, performs specified product inspection, and packs the product 612 having passed the product inspection into a packaging box 614. The packaging boxes 614 having the products 612 packed inside are stacked on the upper surface of a pallet 704, and shipped. Roller conveyors 602, 604 extending along the y-axis direction are disposed inside the production line 15, 16.

The roller conveyor 602, which extends across the modules 1, 2, 3, transports the products 612 in the y-axis direction. The roller conveyor 604, which extends across the modules 3, 4, 5, transports the packaging boxes 614 in the y-axis direction. These roller conveyors 602, 604 can be divided at the boundary lines of the modules 1 to 5 indicated by dashed dotted lines. The module 1 includes a picking-orienting device 160 (a controlled device). The picking-orienting device 160 picks up a product 612 from the roller conveyor 702 and places it on the roller conveyor 602 such that the orientations of the products 12 are aligned.

As an example of a controlled device, one having a signal line to control a motor, a limit switch for sequence control, or the like is conceivable. The signal line, the limit switch, and the like are connected to an I/O module of a control device such as a PLC. Controlled devices can be connected to, instead of an I/O module connected to a base board, a slave I/O module or a slave I/O unit connected to a specified interface included in a communication module inserted in the base board together with the PLC. Depending on the configuration inside the module, tens to hundreds of wires are connected to an I/O module as signal lines in some cases.

In addition, as examples of other types of controlled devices, machine tools such as a machining center, a computerized numerical control (CNC) milling cutter, and a lathe; robots that perform picking, welding, and the like; and motors that perform motion control in consideration of positions and angles are connected to control devices such as PLCs with a specified interface which is different from the I/O module.

Next, the module 2 includes a printing device 260 (a controlled device) and an inspection device 262 (a controlled device). The printing device 260 prints various characters on the product 612. The inspection device 262 performs a specified product inspection on the product 612 and removes the products 612 that failed the product inspection from the roller conveyor 602. The inspection device 262 transports the product 612 that passed the product inspection to the module 3 via the roller conveyor 602.

Next, the module 3 includes a packaging device 360 (a controlled device). The packaging device 360 packages the product 612 into an empty packaging box 614 and seals the packaging box 614. Next, the module 4 includes a box printing device 460 (a controlled device). The box printing device 460 prints various characters on the sealed packaging box 614. Next, the module 5 includes a palletizing device 560 (a controlled device). The palletizing device 560 places the packaging box 614 conveyed from the module 4 on the pallet 704 in an orderly manner.

At the bottom portions of the modules 1 to 5 are disposed base units 110 (a first base unit), 210 (a second base unit), 310 (a third base unit), 410, 510, respectively, each base unit having an approximately rectangular plate shape (these base units are hereinafter referred to as “the base units 110 and so on” in some cases). On the upper surfaces of the base units 110 and so on are respectively provided switches 102, 202, 302, 402, 502; distribution switchboards 104, 204, 304, 404, 504; controllers 106, 206, 306, 406, 506 (control devices, which are hereinafter referred to as the controllers 106 and so on in some cases). The switches 102, 202, 302, 402, 502 are connected to a not-shown power supply line and turn on or off the power for each of the modules 1 to 5. Note that the shape of the base unit 110 is not limited to an approximately rectangular plate shape, but it may be a combination of several frames as long as it is stiff enough to support the devices mounted on the base unit 110.

The distribution switchboards 104, 204, 304, 404, 504 each have a plurality of circuit breakers (not shown) and distribute electricity to each part of the respective modules 1, 2, 3, 4, 5. The controllers 106, 206, 306, 406, 506 control the operation of the respective modules 1, 2, 3, 4, 5. In addition, the base unit 210 of the module 2 is provided with an overall controller 620 that performs overall management on the controllers 106 and so on. The controllers 106 and so on and the overall controller 620 has a configuration of, for example, a general microcomputer. Each of the controllers 106 and so on is connected to the overall controller 620 via a communication cable 622 and performs bidirectional communication with the overall controller 620. The connection method using the communication cable 622 is an example. As an alternative, the overall controller 620 may serve as a master, and the other controllers 106 and so on may be connected in a daisy chain. As another alternative, these may be connected to one another in a multi-drop configuration. The communication between the controllers may be implemented by combining a multi-drop configuration and a daisy chain configuration.

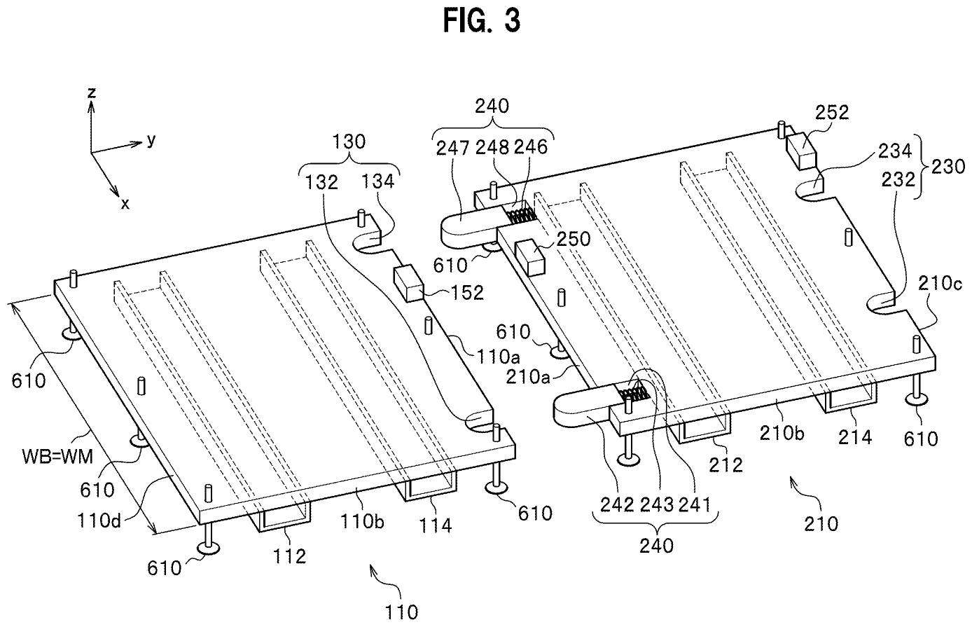

FIG. 3 is a schematic perspective view of the base units 110, 210.

As described above, the base units 110, 210 each have an approximately rectangular plate shape. The width of the base units 110 and so on in the x-axis direction is called the base-unit width WB. In the shown example, the base-unit width WB is equal to the module width WM (see FIG. 1). The surfaces of the base units 110, 210 facing each other are called facing surfaces 110a (a first facing surface) and 210a (a second facing surface). Surfaces adjoining the facing surfaces 110a, 210a are called side surfaces 110b, 210b. The surface of the base unit 110 opposite from the facing surface 110a is called the non-facing surface 110d. The non-facing surface 110d does not face the other base units.

The base unit 110 has adjuster bolts 610 (support member) attached to it at six positions in its peripheral edge portions. The adjuster bolts 610 are for adjusting the height of the base unit 110 relative to the floor surface 11, 21 of the supplier factory 10 or the user factory 20 (see FIG. 1). With this configuration, it is possible to place the base unit 110 on the level even if the floor surface 11, 21 is inclined or has a step.

The base unit 110 has insertion receiving portions 112, 114 fixed to its lower surface, the insertion receiving portions 112, 114 having cross sections in rectangular frame shapes and extending in parallel with each other along the x-axis direction. The forklifts 18, 28 (see FIG. 1) insert their forks 18a, 28a into these insertion receiving portions 112, 114 to lift the base unit 110; thus, the forklifts 18, 28 can stably convey the base unit 110 and the module 1. As with the base unit 110, the base unit 210 also has the adjuster bolts 610 attached to its peripheral edge portions at six positions. The base unit 210 has insertion receiving portions 212, 214 fixed to its lower surface, the insertion receiving portions 212, 214 having configurations formed in the same way as those of the insertion receiving portions 112, 114.

The facing surface 110a of the base unit 110 has a first engagement portion 130. The first engagement portion 130 includes a pair of recesses 132, 134 (first recess) each having an approximately U shape recessed inward from the facing surface 110a. The facing surface 210a of the base unit 210 has a second engagement portion 240. The second engagement portion 240 includes a pair of recesses 241, 246 recessed inward from the facing surface 210a, a pair of urging members 243, 248, and a pair of protruding members 242, 247 (first protrusion).

The urging members 243, 248 are, for example, coil springs, which are movably inserted in the recesses 241, 246, respectively. The protruding members 242, 247 each have an approximately rectangular parallelepiped rod shape, and the end of each protruding member 242, 247 on the side facing the base unit 110 has an approximately U shape formed to conform to the recess 132, 134. The protruding members 242, 247 are pressed into the respective recesses 241, 246 while pressing the respective urging members 243, 248. With this configuration, the urging members 243, 248 urge the protruding members 242, 247 toward the base unit 110. Note that the non-facing surface 110d of the base unit 110 does not have either recesses or protrusions. With this configuration, it possible to prevent a possible situation in which something would be caught at the non-facing surface 110d.

The base unit 110 has an adjoining module adjudicator 152 attached to its upper portion near the facing surface 110a. The base unit 210 has an adjoining module adjudicator 250 attached to its upper portion at the facing surface 210a at the position facing the adjoining module adjudicator 152. The adjoining module adjudicators 152, 250 perform bidirectional proximity wireless communication to each determine whether a module adjoining itself is a right one. If the adjoining module is a wrong one, the adjoining module adjudicators 152, 250 output a warning to that effect. The surface of the base unit 210 opposite from the facing surface 210a is a facing surface 210c (a third facing surface) that faces a base unit 310 (see FIG. 2). At an upper portion near facing surface 210c is attached an adjoining module adjudicator 252 having a configuration the same as or similar to the adjoining module adjudicator 250.

In the present embodiment, modules having the same function have engagement portions having the same configuration. For example, the configurations of the modules 1A, 1B shown in FIG. 1 are as shown in FIG. 2 as the module 1; thus, the modules 1A, 1B have the same function. Hence, both the two base units 110 applied to the modules 1A, 1B have the first engagement portion 130 shown in FIG. 3. Similarly, the configurations of the modules 2A, 2B (see FIG. 1) are as shown in FIG. 2 as the module 2; thus, the modules 2A, 2B have the same function. Hence, both the two base units 210 applied to the modules 2A, 2B have the second engagement portion 240 and a third engagement portion 230 shown in FIG. 3. In other words, the modules 2A, 2B have the protruding members 242, 247 and the recesses 232, 234 at the same positions or approximately at the same positions.

Note that the adjoining module adjudicators 152, 250, and so on provided on the base units 110 and so on distinguish each individual module regardless of whether the functions are the same. Specifically, the adjoining module adjudicator 152 attached to the module 1A distinguishes the adjoining module adjudicator 250 attached to the module 2A and the adjoining module adjudicator 250 attached to the module 2B as different ones. The same is true of other adjoining module adjudicators. Thus, when a worker puts the module 1A and the module 2B close to each other within a specified distance, both the adjoining module adjudicator 152 of the module 1A and the adjoining module adjudicator 250 of the module 2B output warnings indicating that “the adjoining module is a wrong one”.

The adjoining module adjudicators 152, 250, and so on are driven by batteries; hence they function in the state where a commercial power is not supplied (for example, in a state where they are on the conveyance apparatus 30). Thus, when a worker loads the module 1A and the module 2B onto the conveyance apparatus 30 (see FIG. 1), and they adjoin each other, the adjoining module adjudicators 152, 250 output a warning even at that time. This configuration makes it possible to make modules that need to adjoin to each other in the installation work adjoining each other from the transportation stage. This increases the efficiency in the installation work.

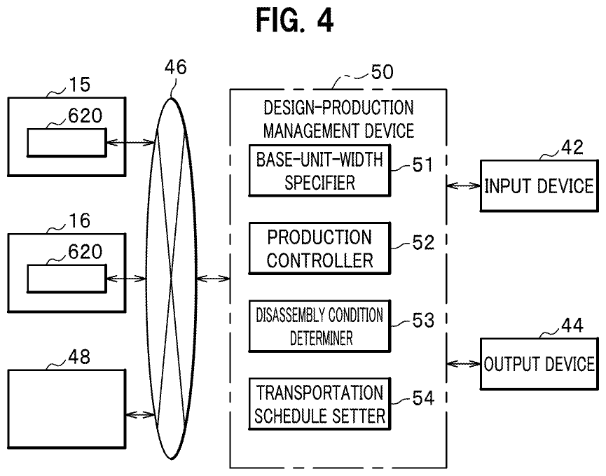

FIG. 4 is a block diagram of the design-production management device 50 and others.

The design-production management device 50 includes hardware of a general computer, such as a central processing unit (CPU), random access memory (RAM), read only memory (ROM), and a solid state drive (SSD). The SSD stores an operating system (OS), application programs, various kinds of data, and the like. The OS and the application programs are loaded into the RAM to be executed by the CPU. In FIG. 4, the blocks inside the design-production management device 50 show the functions implemented by an application program and the like.

Specifically, the design-production management device 50 includes a base-unit-width specifier 51, a production controller 52, a disassembly condition determiner 53, a transportation schedule setter 54, and a production controller 55. The design-production management device 50 is connected to an input device 42 and an output device 44. In addition, the design-production management device 50 is connected to the overall controller 620 of each of the production lines 15, 16 and another information device 48 via a network 46. The design-production management device 50 to be disposed at the area 27 in the user factory 20 shown in FIG. 1 may be different from the design-production management device 50 in the supplier factory 10 or may be the same device. The design-production management device 50 of the user factory 20 may be connected to a manufacturing execution system (MES), or the computer including the functions of the design-production management device 50 may have that function. The design-production management system 50 may be connected to an enterprise resource planning (ERP). Regarding the design-production management device 50, the process to design the production lines 15, 16 in the supplier factory 10, using the design-production management device 50 will be described below.

The input device 42 includes a mouse, a keyboard, and the like (not shown), through which various kinds of information is inputted to the design-production management device 50. The output device 44 includes a display, a printer, and the like (not shown), through which the information supplied from the design-production management device 50 is outputted. The information inputted through the input device 42 is listed as examples in the following. The design-production management device 50 uses these kinds of inputted information as constraint conditions to determine modules and controlled devices to be connected to the controller belonging to the module.
The delivery-entrance widths W12, W22 of the supplier factory 10 and the user factory 20
The loading-platform inside width W32, the loading-platform inside length L32, and the allowable load weight of the conveyance apparatus 30
The module lengths L1, L2, L3, L4, L5 of the modules 1 to 5
The weights of the modules 1 to 5

Note that these kinds of information may be inputted from another information device 48 via the network 46. Since the supplier factory 10 builds the production systems 15, 16, the delivery-entrance width W12 is wider than the delivery-entrance width W22 of the user factory 20 in many cases. Thus, this process can be implemented without inputting the information on the delivery-entrance width W12 to the input device 42.

The base-unit-width specifier 51 determines the base-unit width WB (see FIG. 3) such that the base-unit width WB is narrower than the delivery-entrance width W22 of the user factory 20, to which the production system P (see FIG. 1) is transported, and also narrower than the loading-platform inside width W32. With this process, it is possible to specify the width of the modules so that the production system P can be loaded on the conveyance apparatus 30. The width of the base-unit width WB can also be determined such that it is narrower than the width of the delivery-entrance width W12 of the supplier factory 10. Note that in the case where the delivery-entrance width W22 is narrower than the delivery-entrance width W12, it is possible to improve the efficiency in transportation of the production system P from the supplier factory 10.

The production controller 52 has a function of controlling the production system P by communicating with the overall controllers 620 of the production lines 15, 16 when the production system P actually starts to operate in the user factory 20. Software including Ladder to control the production system P may be installed in another design-production management device 50, which is provided to the user factory 20. In the supplier factory 10, before the production system P is transported to the user factory 20, the production system P is operated in conditions equal to the ones in the user factory 20, and an operation test is performed to check if each device included in the production system P delivers the specified performance. The production controller 52 also has a function to perform this operation test.

The disassembly condition determiner 53 determines a disassembly condition for disassembling the production system P into a plurality of portions in the supplier factory 10. The production lines 15, 16 (see FIG. 1) are disassembled in units of modules. Hence, the disassembly condition determiner 53 has a function of allocating the devices included in the production lines 15, 16 to the modules 1 to 5. To be more specific, the disassembly condition determiner 53 determines the configurations of the modules 1 to 5 such that each of the module lengths L1 to L5 (see FIG. 2) of the modules 1 to 5 does not exceed the loading-platform inside length L32 of the conveyance apparatus 30, and that the weight of each of the modules 1 to 5 does not exceed the allowable load weight of the conveyance apparatus 30.

In this process, the disassembly condition determiner 53 determines the configuration of each module such that a controller (for example, the controller 106 in FIG. 2) and a controlled device (for example, the picking-orienting device 160) that is controlled by the controller will belong to the same module (for example, the module 1) without any exception. Generally, a controlled device and the controller that controls the controlled device are connected with a large number of cables. Since it takes much work time to connect a large number of cables used for control of a controlled device to the I/O module of the PLC, which is the controller, it is desirable that there should be no work at the user factory 20 such as disconnecting a cable and connecting it to another connector or changing the controller to which disconnected cables are to be connected. Patent Literature 1 and Patent Literature 2, which are based on the premise that production lines are changed, do not take account of such a viewpoint. Besides the above wiring work, after wiring is changed, the configurator for recognizing information on the control targets of the controller needs to be set again, and the control software such as Ladder needs to be changed. Further, a unit test to check if each module operates correctly is necessary, and after the unit tests are passed, an overall test is necessary to check if the operation between modules works correctly. Hence, it is desirable to devise ways to reduce the above wiring changes.

Here, to reduce wiring changes, after the production system P is transported to the user factory 20, wiring is not changed. the production system P can be set up by connecting the controllers belonging to the respective modules to one another. Such a method will be described below.

The disassembly condition determiner 53 determines a disassembly condition of the production system P in which the disassembled production system P can be transported efficiently and the production system P can be set up efficiently at the user factory 20. Hence, regarding the configuration of each module, the disassembly condition determiner 53 specifies wiring methods between the controlled devices to be included in each one of the modules 1, 2, 3, 4, 5 the widths of which have been specified and the controllers 106, 206, 306, 406, 506.

For example, in the case where the picking device 160 of the module 1 has separate picking means and orienting means, the picking device 160 detects and holds the product 612, changes the angle and position of the product 612, and then places the product 612 on the roller conveyor 602 such that there is a specified distance between products 612. To perform these operations, the number of the control signal lines sometimes exceeds the number of the input and output ports of the I/O module of the controller 106.

In such a case, sometimes the picking-orienting device 160 is divided, and part of the device is transferred to the module 2. After that, the disassembly condition determiner 53 determines whether the I/O module of the controller 206 of the module 2 can accommodate the wiring of the printing device 206 and the device transferred from the module 1. Then, the wiring specifying process to specify the wiring method for each module is repeated from the module 2 to the module 5 which have been specified as the units of disassembling.

In this example, whether wiring is possible is determined by comparing the number of ports in the I/O and the number of wiring lines. However, in the case of using PLCs or the like, it is necessary to take account of processes of reading and writing of the states of the controlled devices at specified intervals, called scan and cycle.

In the case where processing of the controller 106 that is connected to the overall controller 620 is processed in the same scan time, a constraint condition that reading and writing information on the controlled devices belonging to the module 1 should be completed within a specified scan time can be added.

Specifically, if a module includes many controlled device that require a long time for writing and reading, processes may not be finished within the scan time of the overall controller 620 in some cases. Hence some of the controlled devices are relocated to belong to other modules, and the controller to which the controlled devices are connected is changed so that the time required for scanning each controller can be leveled. With this process, it is possible to set a configuration in which scanning of all the modules can be completed within the scan time of the overall controller 620. Note that it is possible not to change wiring by allowing a longer scan time of the overall controller 620. In contrast, in the case where the controllers 106 and so on each have an individual scan time, in other words, in the case where each controller operates independently, which module each controlled device should belong to can be set relatively flexibly.

In addition to determining whether wiring of each module can be connected to the I/O module, a motion module, or the like of each controller, there are cases of determining the weight balance of each module, and performing a process for changing the positions of devices. Specifically, although each module is supposed to be lifted and transported by the forklifts 18, 28 shown in FIG. 1, depending on the arrangement method of the devices in a module, the center of gravity is not near the center of the module, and there are cases where the forks 18a, 28a cannot lift it. In the case where a module has the center of gravity that is expected not to allow the fork 18 to lift the module up, the positions of the devices in the module are changed, or some of the devices are transferred to an adjoining module.

In other words, the disassembly condition determiner 53 performs a process to determine the weight balance or the center of gravity of the module having a width that allows transportation, and after that, it performs a process for changing the positions of devices so that a specified condition can be satisfied or a process for changing the positions of devices by changing the module to which specified devices belong. In the case where the positions of devices are changed, the wiring method is determined again.

Even if the above wiring determination process and the process of changing the positions of devices are executed, there are cases where it is impossible to determine units of modules for disassembling. In such a case, the number of modules for disassembling can be increased, and then the wiring determination process and the device position changing process are performed.

The number of modules for disassembling can be set to a certain number by the supplier and can be automatically calculated and determined based on the information inputted from the input device 42. From the experience of the supplier, the widths, sizes, and shapes of the modules and the devices to be disposed in them can be inputted and set as constraint conditions. As another alternative, the supplier fixes or specifies how to divide a production line into modules and the positions of devices in the modules so that the supplier can meet the demands from the user, and the supplier inputs those conditions and can use the inputted information as part of the constraint conditions.

The design-production management device 50 repeats calculation until units of modules are determined that meet the conditions of these constraint conditions and the information inputted to the foregoing input device 42. In other words, the design-production management device 50 determines the widths and depths of the modules, the number of the modules, the wiring between the controllers and the controlled devices, and the weight balance and the center of gravity of each module that satisfy the constraint conditions. Through this process, it is possible to determines modules that can be efficiently disassembled and transported and that can be efficiently assembled and set up in the user factory 20.

Since in the present embodiment, a controlled device and the controller that controls the controlled device are included in the same module, it is possible to perform disassembling work, transportation, and installation work without disconnecting a large number of cables connecting those devices. This saves man-hour for the disassembling work at the supplier factory 10 and the installation work at the user factory 20. This in turns shortens the time for assembling and setting up the production system P in the user factory 20. Thus, the user can start manufacturing products earlier than in the case of conventional systems, and the supplier can provide a production system with a high added value to the user who is a customer.

The transportation schedule setter 54 determines the order of the modules, which are units for disassembling, at the time when they are mounted on the conveyance apparatus 30 and transported from the supplier factory 10 to the user factory 20. One or a plurality of modules that can be transported at the same time are ones within the range that can be accommodated in the loading platform 32 of the conveyance apparatus 30, and the total weight of which is lighter than or equal to the allowable load weight of the conveyance apparatus 30. For example, assume that the module lengths L1 to L5 of the modules 1 to 5 (see FIG. 2) and the loading-platform inside length L32 of the conveyance apparatus 30 (see FIG. 1) have relationships “L1+L2≤L32” and “L3+L4+L5≤L32” between them. In this case, it is conceivable to transport the modules 1A, 2A (see FIG. 1) of the production line 15 as a first delivery of the conveyance apparatus 30, transport the modules 3A, 4A, 5A as a second delivery, transport the modules 1B, 2B of the production line 16 as a third delivery, and transport the modules 3B, 4B, 5B as a fourth delivery. Defining that the remaining space of the conveyance apparatus 30 for the first delivery is “L32−L1−L2=La”; for the second delivery, “L32−L3−L4−L5=Lb”; and for the fourth delivery, “L32−L3−L4−L5=Lc”, the relationship “L1+L2 La+Lb+Ld” holds for the third delivery. In this case, if the modules 1B and 2B are disassembled, the transportation is possible without using the third delivery by only the first delivery, the second delivery, and the fourth delivery, which means the total three times of delivery. However, even if the conveyance apparatus 30 has a spare space, the time for assembling and setting up at the user factory 20 can be shortened by setting transportation times or transportation delivery times in units of modules, not disassembling the modules 1B and 2B.

When the conveyance apparatus 30 has a spare space, transportation and set-up can be made efficient by loading parts, tools, and others that do not belong to the modules and the design-production management device 50. For doing it, the sizes, shapes, and weights of parts that do not belong to modules may be inputted as part of the constraint conditions. In the case where a plurality of module transportation patterns can be determined, the delivery schedule may preferably be determined in consideration of transportation of parts that do not belong to modules.

The transportation order of modules may preferably be the order of production processes in the production line P or the order in which the installation place of the module is farther from the delivery entrance 22. The reason is that when the unit operation test is performed for each module in the user factory 20, the operation test can be performed in the ascending order of production processes (in the order in which the process is earlier), and thus the set-up time can be shortened. When the modules are installed in the order in which the installation place of the module is farther from the delivery entrance 22, a large empty space can be left near the delivery entrance 22, and this makes the module assembling work efficient.

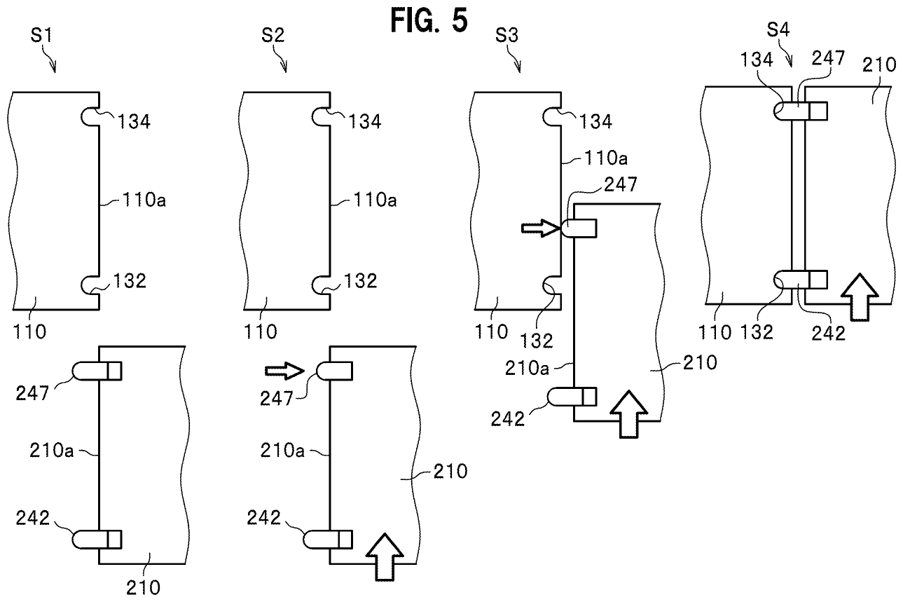

FIG. 5 is a diagram showing the relationship between the base units 110, 210 in the installation work.

In FIG. 5, in step S1, workers install the module 1 (see FIG. 2) at a specified position on a floor surface 21 (see FIG. 1) of the user factory 20 and fixes the module 1 to the floor surface 21. A worker operates the forklift 28 (see FIG. 1) to lift the module 2 with the base unit 210 and places the module 2 such that the facing surfaces 110a, 210a are aligned along the x axis.

Next, in step S2, the worker, while pushing the protruding member 247 of the base unit 210 into the base unit 210 (see the narrow white arrow), moves forward the module 2 with the base unit 210 in the direction of the thick white arrow. During this process, the protruding member 247 is kept pushed in so that the protruding member 247 will not get into the recess 132. Next, in step S3, after the protruding member 247 has passed by the recess 132, the worker releases the protruding member 247. However, because the movement of the protruding member 247 is restricted by the facing surface 110a of the base unit 110, the protruding member 247 is kept pushed in the facing surface 210a. Then, the worker pushes the protruding member 242 into the base unit 210 and moves the module 2 further forward.

Next, in step S4, when the module 2 has moved forward to the position where the base units 110 and 210 are aligned, the worker releases the protruding member 242. With this, the protruding member 242 fits into the recess 132. At the same time, the protruding member 247 also fits into the recess 134. Through this process, the worker can position the module 2 precisely relative to the module 1 and thus the worker can perform the installation work for the module 2 in a rapid manner. Although the base units 310, 410, 510 of the modules 3, 4, 5 are omitted in FIG. 5, the worker can place the modules 3, 4, 5 sequentially in procedure the same as or similar to that for the module 2.

FIG. 6 is a diagram showing the positional relationship between the engagement portions of base units.

As described above, the first engagement portion 130 provided in the facing surface 110a of the base unit 110 includes the recesses 132, 134. Here, assume that the center positions of the two in the x-axis direction are x6, x1. The second engagement portion 240 provided in the facing surface 210a of the base unit 210 includes the protruding members 242, 247. The center positions of the two in the x-axis direction are equal to the foregoing center positions x6, x1. Thus, the first engagement portion 130 and the second engagement portion 240 can be engaged.

The third engagement portion 230 provided in the facing surface 210c of the base unit 210 includes the recesses 232, 234 (second recess). Here, assume that the center positions of the two in the x-axis direction are x5, x3. A fourth engagement portion 340 provided in a facing surface 310a (fourth facing surface) of the base unit 310 includes protruding members 342, 347 (second protrusions). The center positions of the two in the x-axis direction are equal to the foregoing center positions x5, x3. Thus, the third engagement portion 230 and the fourth engagement portion 340 can be engaged.

A fifth engagement portion 330 provided in a facing surface 310c of the base unit 310 includes recesses 332, 334. Here, assume that the center positions of the two in the x-axis direction are x4, x2. A sixth engagement portion (not shown) provided in the base unit 410 includes protruding members (not shown) that fit into the recesses 332, 334. The center positions of the two in the x-axis direction are equal to the foregoing center positions x4, and x2. Thus, the fifth engagement portion 330 and the sixth engagement portion (not shown) can be engaged.

### Advantageous Effects of First Embodiment

In the preferred embodiment described above, the production system P is a production system P including the plurality of control devices (106, 206, 306, 406, 506) and the plurality of controlled devices (160, 260, 262, 360, 460, 560) each connected to one of the control devices (106 and so on), the production system P including: a base-unit-width specifier 51 that specifies a base-unit width WB that is the common width of the plurality of base units (110, 210, 310, 410, 510) on which the plurality of control devices (106 and so on) and the plurality of controlled devices (160 and so on) are mounted, such that the base-unit width WB is narrower than all of a first delivery-entrance width (W12) that is the width of a delivery entrance in a first region (10) from which the production system P is transported, a second delivery-entrance width (W22) that is the width of a delivery entrance of a second region (20) to which the production system P is transported, and an allowable width (W32) of a conveyance apparatus 30 that transports the production system P from the first region (10) to the second region (20); a production controller 52 that performs an operation test on the controlled devices (160 and so on) in the first region (10) in a state where the plurality of control devices (106 and so on) and the plurality of controlled devices (160 and so on) are mounted on the plurality of base units (110 and so on) having the specified base-unit width WB; a disassembly condition determiner 53 that determines a disassembly condition to disassemble the production system P in units of modules, such that each of the control devices (106 and so on) and the corresponding one of the controlled devices (160 and so on) are included in the same one of the modules 1A to 5A and 1B to 5B, and the dimension and weight of each of the modules 1A to 5A and 1B to 5B do not exceed an allowable dimension and an allowable load weight of the conveyance apparatus 30; and a transportation schedule setter 54 that determines the order in which the plurality of modules 1A to 5A and 1B to 5B are transported from the first region (10) to the second region (20).

Another aspect of the preferred embodiment is a method of assembling a production system (P) including a plurality of control devices (106, 206, 306, 406, 506) and a plurality of controlled devices (160, 260, 262, 360, 460, 560) each connected to one of the control devices (106, and so on), the method including: a base-unit-width specifying step (51) of specifying a base-unit width (WB) that is the width of a plurality of base units (110, 210, 310, 410, 510) on which the plurality of control devices (106 and so on) and the plurality of controlled devices (160 and so on) are mounted, such that the base-unit width (WB) is narrower than a second delivery-entrance width (W22) that is the width of a delivery entrance of a second region (20) to which the production system (P) is transported and an allowable width (W32) of a conveyance apparatus (30) that transports the production system (P) from a first region (10) to the second region (20); an operation test step (52) of performing an operation test on the controlled devices (160 and so on) in the first region (10) in a state where the plurality of control devices (106 and so on) and the plurality of controlled devices (160 and so on) are mounted on the plurality of base units (110 and so on) having the specified base-unit width (WB); a disassembly condition determination step (53) of determining a disassembly condition to disassemble the production system (P) in units of modules, such that each of the control devices (106 and so on) and the corresponding one of the controlled devices (160 and so on) are included in the same module (1A to 5A, 1B to 5B), and the dimension and weight of each module (1A to 5A, 1B to 5B) do not exceed an allowable dimension and an allowable load weight of the conveyance apparatus (30); and a transportation schedule setting step (54) of determining the order in which the plurality of modules (1A to 5A, 1B to 5B) are transported from the first region (10) to the second region (20). For the production system P with this configuration, it is possible to determine an appropriate disassembly condition and an appropriate transportation order for the production system P, making it possible to shorten the installation time and the set-up time of the production system P. Note that the disassembly condition determiner 53 which determines the disassembly condition to disassemble the production system P in units of modules does not necessarily have to set the condition that the base-unit width WB is narrower than the first delivery-entrance width (W12).

It is more preferable that each of the base units (110 and so on) include an insertion receiving portion (112, 114, 212, 214, and so on) into which a fork 18a, 28a of a forklift 18, 28 is inserted, and that the modules 1A to 5A and 1B to 5B can be transported in the first or second region (10, 20) by the forklift 18, 28 inserting the fork 18a, 28a into the insertion receiving portion (112, 114, 212, 214, and so on) of the modules 1A to 5A and 1B to 5B to support the modules 1A to 5A and 1B to 5B. With this configuration, it is possible to convey the modules 1A to 5A and 1B to 5B efficiently by using the forklift 18, 28, making it possible to further shorten the installation time of the production system P.

It is more preferable that each of the base units (110 and so on) include a support member (610) with which the height of each base unit (110 and so on) can be adjusted relative to the floor surface 11, 21 where the base unit is installed. With this configuration, it is possible to absorb an inclination, irregularities, or the like on the floor surface 11, 21.

It is more preferable that the plurality of modules 1A to 5A and 1B to 5B include a first module (1A) and a second module (2A) that face each other, that a first base unit (110) included in the first module (1A) have a first facing surface (110a) configured to face the second module (2A) and have at least one first recess (132, 134) in the first facing surface (110a), that a second base unit (210) included in the second module (2A) have a second facing surface (210a) configured to face the first module (1A) and have at least one first protrusion (242, 247) in second facing surface (210a), and that the first recess (132, 134) and the first protrusion (242, 247) be associated with each other. With this configuration, since the first recess (132, 134) and the first protrusion (242, 247) can be associated with each other, it is possible to install the first module (1A) and the second module (2A) appropriately.

It is more preferable that the first protrusion (242, 247) have a structure with which when being pressed, the first protrusion (242, 247) is pushed in to a position where the first protrusion (242, 247) is flush with the second facing surface (210a) or further in from the second facing surface (210a), that, with this configuration, after the first module (1A) is installed on the floor surface 11, 21, the position of the second module (2A) be adjusted while the first protrusion (242, 247) is pushed in by the first facing surface (110a) when transporting the second module (2A) to a position adjoining the first module (1A) by using the forklift 18, 28, and that in a case the first protrusion (242, 247) protrudes toward the first facing surface (110a) in a state where a support member (610) supports the second module (2A), the fork 18a, 28a can be pulled out of the insertion receiving portion (112, 114, 212, 214, and so on). With this configuration, when moving the second module (2A) by using the forklift 18, 28 or the like, it is possible to move the second module (2A) linearly, making it possible to further shorten the installation time of the production system P.

It is more preferable that the first protrusion (242, 247) and the first recess (132, 134) have a relationship in which the first and second base units (110, 210) face or come in contact with each other by the first protrusion (242, 247) being inserted into the first recess (132, 134). This configuration makes it possible to position the first and second base units (110, 210) rapidly and appropriately, further shortening the installation time of the production system P.

It is more preferable that the plurality of modules 1A to 5A and 1B to 5B further include a third module (3A), the third module (3A) and the second module (2A) being configured to face each other, that the second base unit (210) have a third facing surface (210c) configured to face the third module (3A) and have at least one second recess (232, 234) in the third facing surface (210c), that a third base unit (310) included in the third module (3A) have a fourth facing surface (310a) configured to face the second module (2A) and have at least one second protrusion (342, 347) in the fourth facing surface (310a), that the second recess (232, 234) and the second protrusion (342, 347) be associated with each other, and that the first protrusion (242, 247) and the second protrusion (342, 347) have different positions in a direction (the x-axis direction) along a horizontal plane and in parallel with the first facing surface (110a). Since the first protrusion (242, 247) and the second protrusion (342, 347) have different positions as described above, it is possible to reduce the possibility of confusing the second module (2A) and the third module (3A), making it possible to further shorten the installation time of the production system P.

It is more preferable that the plurality of modules 1A to 5A and 1B to 5B further include a fourth module (2B) that has the same function as the second module (2A), and that the fourth module (2B) have a protrusion approximately at the same position as the first protrusion (242, 247) of the second module (2A) and have a recess approximately at the same position as the second recess (232, 234). With this configuration, modules having the same specification can use the same or approximately the same base unit, and this can reduce the production cost by applying the mass production effect.

It is more preferable that the first base unit (110) have a non-facing surface (110d) that is opposite from the first facing surface (110a), the non-facing surface (110d) being configured not to face any of the modules 1A to 5A and 1B to 5B and not having a protrusion. With this configuration, it is possible to prevent such a situation that something is caught at the non-facing surface 110d.

It is more preferable that the plurality of control devices (106 and so on) be connected to one another via a communication cable 622. This configuration enables the control devices (106 and so on) to appropriately communicate with one another.

It is more preferable that the association of connections between the plurality of control devices (106, 206, 306, 406, 506) and the plurality of controlled devices (160, 260, 262, 360, 460, 560) in the operation test performed in the first region (10) be kept also in the second region (20). With this process, since the configuration between the modules and the configuration between the controllers of the production system P that operated appropriately in the operation test in the supplier factory 10 can be kept after the installation work in the user factory 20, it is possible to increase the possibility that the production system P operates appropriately.

It is more preferable that at least one of the control devices (106 and so on) be connected to the other control devices. This enables the plurality of control devices to work in cooperation. Since the control devices are connected to one another via a specified interface, and thus, the modules are connected to one another, there is no possibility that the first controller belonging to the first module controls controlled devices belonging to the second module. This reduces wiring changes at the user factory 20 and effects for other modules.

The first control device (106 and so on) and the second control device may be connected by using specified connectors and a communication interface specified in a specification. Interfaces such as the I/O module of the PLC in which the ports used can be flexibly changed need to identify or recognize information on the controlled device after the signal line is plugged in. However, an interface for communication allows the production system P to start to operate by connecting the control devices to one another at the user factory 20.

It is more preferable that each of the modules 1A to 5A and 1B to 5B include a switch (102 and so on) or a distribution switchboard (104 and so on) for supplying electric power to the associated control device (106 and so on). With this configuration, it is possible to control the supply of electric power for each module. Since the modules transported to the user factory 20 have independent controllers and independent power supplies, it is possible to perform the operation test for each individual module as soon as the module is installed.

It is more preferable that the plurality of modules 1A to 5A and 1B to 5B include a first module (1A) and a second module (2A) that adjoin each other, and that the control device (206) of the second module (2A) have a function of, when detecting that electric power is not supplied to the first module (1A), stopping work related to the first module (1A). Instead of the stopping of work, a module may preferably have a preset process to assist the work of the module in the previous process when electric power in the adjoining module for the previous process is down. For example, in the case where the previous process performs printing of the best before date, and the next process performs a similar process such as printing of other kinds of information, it is possible to continues the production by transporting work-in-process to the next module by using a belt conveyor or the like and by adding the work process in the next module. By doing this, when electric power of one module is down, it is possible to reduce effects to the other modules.

It is more preferable that each of the modules 1A to 5A and 1B to 5B include an adjoining module adjudicator (152, 250, and so on) that determines whether another module adjoining the module is a right module, and that the adjoining module adjudicator (152, 250, and so on) determine whether another module adjoining the module is a right module also when the module is being transported by the conveyance apparatus 30. This configuration encourages workers to place the modules that should adjoin each other in the installation work such that they adjoin each other also in the transportation stage, and this further increases the efficiency in the installation work.

By assigning an identification ID to each module and by using Radio Frequency Identification (RFID) or short-distance wireless communication, the adjoining module adjudicator (152, 250, and so on) can determine whether an adjoining module or an approaching module is a right module.

### Modification Example

The present invention is not limited to the foregoing embodiment, but various modifications are possible. The foregoing embodiment was described as an example to make the present invention easier to understand; hence, the present invention is not limited to configurations having all the described constituents. The above embodiment may have other constituents in addition to the constituents described above, or some of the constituents may be replaced with other constituents. The control lines and information lines in the figures are only ones that may be necessary for description; hence, those are not necessarily all the control lines and information lines necessary for the product. It can be thought that in reality, almost all the constituents are connected to one another. The following shows examples of possible modifications to the above embodiment.

(1) In the example shown in FIG. 6, the first engagement portion 130 includes the two recesses 132, 134, and the second engagement portion 240 includes the two protruding members 242, 247. Here, alternatively, the first engagement portion 130 may include only one of the recesses 132, 134, and the second engagement portion 240 may include only the corresponding one of the protruding members. In other words, each engagement portion only needs to include at least one recess or protruding member. The same is true of the other engagement portions such as the third engagement portion 230 and the fourth engagement portion 340.

(2) The hardware of the design-production management device 50 in the above embodiment can be a general computer; hence, the program and the like for executing the foregoing various processes can be distributed by storing them in storage media or via transmission lines

(3) Although the foregoing processes in the above embodiment have been described as software processes using programs, some or all of them may be replaced with hardware processes using an application specific integrated circuit (ASIC), a complex programmable logic device (CPLD), a field programmable gate array (FPGA), or the like.

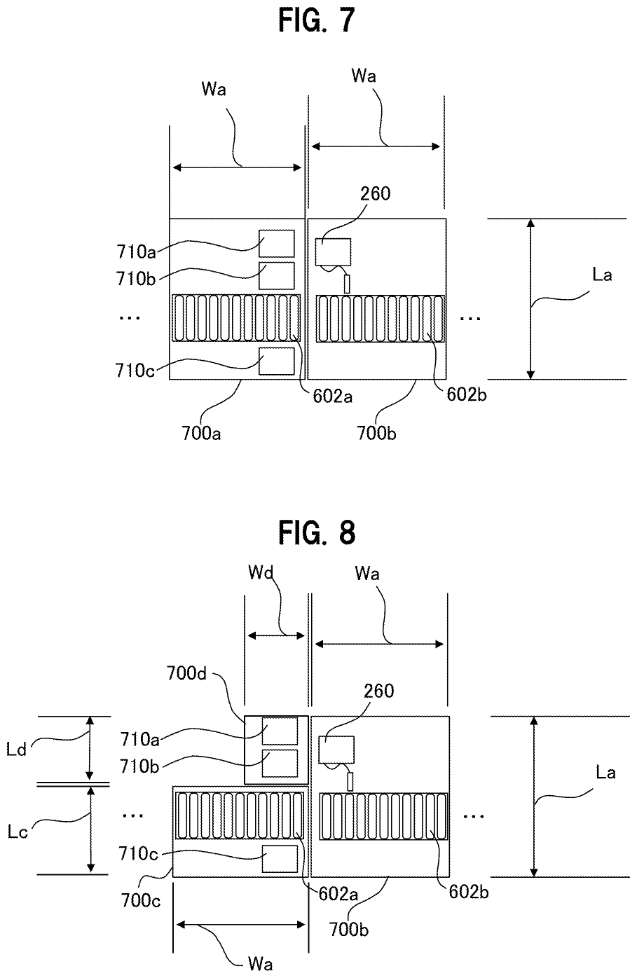

(4) The other modification examples will be described with reference to FIGS. 7 and 8.

FIG. 7 is a diagram showing a display example of modules 700a, 700b in a modification example.

As in the foregoing embodiment, the design-production management device 50 (see FIG. 4) specifies units of modules for disassembling by using the base-unit-width specifier 51, the disassembly condition determiner 53, and the transportation schedule setter 54. FIG. 7 shows a display of the module 700a and the module 700b in an enlarged scale, which are part of units of the production system P for disassembling, in a display included in the output device 44. In the module 700a, production devices 710a, 710b, 710c are arranged near a roller conveyor 602a, and these devices are supposed to be connected to a not-shown controller.

The module 700b includes a roller conveyor 602b and a printing device 260. The width of the modules 700a and 700b is a width Wa, and the length in the depth direction is a length La.

The disassembly condition determiner 53 (see FIG. 4) determines that the center of gravity of the module 700a is displaced to the right side in the figure. However, in the case where the arrangement of the production devices 710a, 710b, 710c cannot be changed due to the requirement of the production process, the module 700a cannot be transported by the forklifts 18, 28, and this situation is not preferable. In this case, the base-unit-width specifier 51 (see FIG. 4) changes the size of the base unit. Specifically, the base-unit-width specifier 51 can change, not only the widths of the base units, but also the lengths in the depth direction and the number of base units.

FIG. 8 is a diagram showing a display example in which the module configuration in FIG. 7 is changed.

Specifically, in FIG. 8, the base-unit-width specifier 51 increased the number of base units, specified the sizes of the base units, and is displaying three base units on the display. The module 700a shown in FIG. 7 was divided into a module 700c and a module 700d in FIG. 8. The base-unit width of the module 700c is the same as the base-unit width Wa of the module 700a. However, the length of the module 700c was changed to a length Lc. Similarly, the width of the base unit of the module 700d was changed to a width Wd, and the length was changed to a length Ld.

Each of the module 700c and the module 700d has a controller belonging to each module, and each controller is connected to the devices included in each module. Fork support portions of the base units of the module 700c and the module 700d may be oriented in different directions as necessary. In that case, the transportation schedule setter 54 can change the transportation order.

As described above, the size and shape of the module, and the number of modules can be changed in consideration of the center of gravity and the weight balance of the module. This makes it possible to set up the production system efficiently. Note that the user can input the number of base units and the sizes of the base units, and these conditions can be used as constraint conditions for the base-unit-width specifier 51. Further, the base-unit-width specifier 51 and the disassembly condition determiner 53 can preferably repeat calculation to specify further appropriate modules.

### REFERENCE SIGNS LIST

1A to 5A, 1B to 5B module
1A module (first module)
2A module (second module)
3A module (third module)
2B module (fourth module)
10 supplier factory (first region)
11, 21 floor surface
18, 28 forklift
18a, 28a fork
20 user factory (second region)
30 conveyance apparatus
51 base-unit-width specifier
52 production controller
53 disassembly condition determiner
54 transportation schedule setter
102, 202, 302, 402, 502 switch
104, 204, 304, 404, 504 distribution switchboard
106, 206, 306, 406, 506 controller (control device)
110 base unit (first base unit)
110a facing surface (first facing surface)
110d non-facing surface
112, 114, 212, 214 insertion receiving portion
132, 134 recess (first recess)
152, 250, 252 adjoining module adjudicator
160 picking-orienting device (controlled device)
210 base unit (second base unit)
210a facing surface (second facing surface)
210c facing surface (third facing surface)
232, 234 recess (second recess)
242, 247 protruding member (first protrusion)
260 printing device (controlled device)
262 inspection device (controlled device)
310 base unit (third base unit)
310a facing surface (fourth facing surface)
342, 347 protruding member (second protrusion)
360 packaging device (controlled device)
410, 510 base unit
460 box printing device (controlled device)
560 palletizing device (controlled device)
610 adjuster bolt (support member)
622 communication cable
P production system
WB base-unit width
W12 delivery-entrance width (first delivery-entrance width)
W22 delivery-entrance width (second delivery-entrance width)
W32 loading-platform inside width (allowable width)

1. A production system including a plurality of control devices and a plurality of controlled devices each connected to one of the control devices, comprising:
a base-unit-width specifier that specifies a base-unit width that is the width of a plurality of base units on which the plurality of control devices and the plurality of controlled devices are mounted, such that the base-unit width is narrower than a second delivery-entrance width that is the width of a delivery entrance of a second region to which the production system is transported or an allowable width of a conveyance apparatus that transports the production system from a first region to the second region;
a production controller that performs an operation test on the controlled devices in the first region in a state where the plurality of control devices and the plurality of controlled devices are mounted on the base units having the specified base-unit width;
a disassembly condition determiner that determines a disassembly condition to disassemble the production system in units of modules, such that each of the control devices and the corresponding one of the controlled devices are included in the same module, and that the dimension and weight of each module do not exceed an allowable dimension and an allowable load weight of the conveyance apparatus; and
a transportation schedule setter that determines the order in which the plurality of modules are transported from the first region to the second region.

2. The production system according to claim 1, wherein
the base-unit-width specifier specifies the base-unit width, further adding a condition that the base-unit width are narrower than a first delivery-entrance width that is the width of a delivery entrance of the first region from which the production system is transported.

3. The production system according to claim 1, wherein
the disassembly condition determiner, in a case where the weight or the center of gravity of the module does not satisfy a specified condition, adds a condition to specify the base-unit width, makes the base-unit-width specifier specify the base-unit width again with the additional condition included, and then sets the disassembly condition again.

4. The production system according to claim 1, wherein
each of the base units includes an insertion receiving portion into which a fork of a forklift is inserted.

5. The production system according to claim 4, wherein
each of the base units includes a support member with which the height of the base unit can be adjusted relative to a floor surface where the base unit is installed.

6. The production system according to claim 5, wherein
the plurality of modules include a first module and a second module that face each other,
a first base unit included in the first module has a first facing surface configured to face the second module and has at least one first recess in the first facing surface,
a second base unit included in the second module has a second facing surface configured to face the first module and has at least one first protrusion in the second facing surface, and
the first recess and the first protrusion are associated with each other.

7. The production system according to claim 6, wherein
the first protrusion and the first recess have a relationship in which the first and second base units face each other or come in contact with each other by the first protrusion being inserted into the first recess.

8. The production system according to claim 7, wherein
the plurality of modules further include a third module, the third module and the second module being configured to face each other,
the second base unit has a third facing surface configured to face the third module and has at least one second recess in the third facing surface,
a third base unit included in the third module has a fourth facing surface configured to face the second module and has at least one second protrusion in the fourth facing surface,
the second recess and the second protrusion are associated with each other, and
the first protrusion and the second protrusion have different positions in a direction along a horizontal plane and in parallel with the first facing surface.

9. The production system according to claim 8, wherein
the plurality of modules further include a fourth module that has the same function as the second module, and
the fourth module has a protrusion approximately at the same position as the first protrusion of the second module and has a recess approximately at the same position as the second recess.

10. The production system according to claim 6, wherein
the first base unit has a non-facing surface that is opposite from the first facing surface, the non-facing surface being configured not to face any of the modules and not having a protrusion.

11. The production system according to claim 1, wherein
the plurality of control devices are connected to one another via a communication cable.

12. The production system according to claim 10, wherein
at least one of the control devices is connected to the other control devices.

13. The production system according to claim 10, wherein
each of the modules includes a switch or a distribution switchboard for supplying electric power to the associated one of the control devices.

14. The production system according to claim 13, wherein
a control device of the control devices, the control device being included in the second module, has a function of, when detecting that electric power is not supplied to the first module, stopping work related to the first module.

15. The production system according to claim 1, wherein
each of the modules has an adjoining module adjudicator that determines whether another module adjoining the module is a right module, and
the adjoining module adjudicator determines whether another module adjoining the module is a right module, when the module is being transported by the conveyance apparatus.

16. A method of assembling a production system including a plurality of control devices and a plurality of controlled devices each connected to one of the control devices, the method comprising:
a base-unit-width specifying step of specifying a base-unit width that is the width of a plurality of base units on which the plurality of control devices and the plurality of controlled devices are mounted, such that the base-unit width is narrower than a second delivery-entrance width that is the width of a delivery entrance of a second region to which the production system is transported or an allowable width of a conveyance apparatus that transports the production system from a first region to the second region;
an operation testing step of performing an operation test on the controlled devices in the first region in a state where the plurality of control devices and the plurality of controlled devices are mounted on the base units having the specified base-unit width;
a disassembly condition determining step of determining a disassembly condition to disassemble the production system in units of modules, such that each of the control devices and the corresponding one of the controlled devices are included in the same module, and that the dimension and weight of each module do not exceed an allowable dimension and an allowable load weight of the conveyance apparatus; and
a transportation schedule setting step of determining the order in which the plurality of modules are transported from the first region to the second region.

17. The method of assembling a production system according to claim 16, wherein
the base-unit-width specifying step specifies the base-unit width, further adding a condition that the base-unit width is narrower than a first delivery-entrance width that is the width of a delivery entrance of the first region from which the production system is transported.

18. The method of assembling a production system according to claim 16, wherein
the disassembly condition determining step, in a case where the weight or the center of gravity of the module does not satisfy a specified condition, adds a condition to specify the base-unit width, makes the base-unit-width specifying step specify the base-unit width again with the additional condition included, and then sets the disassembly condition again.

19. The method of assembling a production system according to claim 16, wherein
each of the modules include an insertion receiving portion into which a fork of a forklift is inserted, and
the method further comprises a transportation step of transporting the modules in the first or second region by the forklift inserting the fork into the insertion receiving portion of the module to support the module.

20. The method of assembling a production system according to claim 16, wherein
the association of connections between the plurality of control devices and the plurality of controlled devices in the operation test performed in the first region is kept also in the second region.

21. The method of assembling a production system according to claim 19, wherein
the plurality of modules includes a first module and a second module that face each other,
a first base unit included in the first module has a first facing surface configured to face the second module and has at least one first recess in the first facing surface,
a second base unit included in the second module has a second facing surface configured to face the first module and has at least one first protrusion in the second facing surface,
the first protrusion and the first recess have a relationship in which the first and second base units face each other or come in contact with each other by the first protrusion being inserted into the first recess,
in addition, the first protrusion has a structure with which when being pressed, the first protrusion is pushed into a position where the first protrusion is flush with the second facing surface or further in from the second facing surface, and
the method further comprises a step of installing the second module by, after the first module is installed on a floor surface, adjusting the position of the second module while the first protrusion is pushed in by the first facing surface when transporting the second module to a position adjoining the first module by using the forklift and, in a case where the first protrusion protrudes toward the first facing surface in a state where a support member supports the second module, pulling the fork out of the insertion receiving portion.
